(19) United States
(12) Patent Application Publication
(10) Pub. No.: US 2006/0277325 A1
(43) Pub. Date: Dec. 7, 2006

(54) Efficient data transmission system and method via direct memory access controller

(75) Inventors: Chuanen Jin, Beijing (CN); Jun Wang, Beijing (CN); David Xiao D. Yang, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/262,153

(22) Filed: Oct. 28, 2005

(30) Foreign Application Priority Data
Jun. 6, 2005 (CN) 200510074950.X

(51) Int. Cl. G06F 13/28

(52) U.S. Cl. 710/22

(57) ABSTRACT

Techniques for efficient data transmission via DMA Controller are disclosed. A data transmission system comprises a data source unit, a data destination unit, a CPU, a DMA command queue controller and a DMA controller. The data destination unit provides data required to be transmitted and the data destination unit is to receive the data. The CPU receives data transmission requests in a batch. The DMA command queue controller is provided to store the data transmissions requests from the CPU. The DMA controller is configured by the DMA command queue controller according to the data transmission requests and controls the data transmission between the data source unit and the data destination unit.

### BACKGROUND OF THE INVENTION

1. Field of the Invention

The present invention relates to the area of data transmission. In particular, the present invention is related to efficient data transmission system and method via a direct memory access controller.

2. Description of Related Art

In general, data transmission between a computer system and peripheral equipments, or different internal memories of the computer systems is conducted via a central processing unit (CPU). The CPU can adopt a program control method or an interruption method to control the data transmission with the peripheral equipments, but both of these two data transmission methods are relatively slow. When a large amount of data need to be transmitted between a high speed peripheral equipment and an internal memory of the computer system, or between the internal memories of the computer system, these two kinds of data transmission modes limit the data transmission rate by a certain extent.

In order to improve the data transmission rate between the computer system and the peripheral equipment, or between the different internal memories of the computer-system, a DMA (Direct Memory Accessing) technology has emerged. The DMA technology is a high speed data transmission operation, allowing direct data access between the computer system and the peripheral equipment or the different internal memories of the computer system. Namely, the data transmission is not through the CPU or without the interference of the CPU. The whole data transmission operation is controlled by a DMA controller, except giving start and end commands of the data transmission at the start and the end of the data transmission. The CPU does not involve in any other processing. Thus, at most time, CPU process other events and the data transmission can be conducted simultaneously, which greatly improves the efficiency of the whole computer system,

Similarly, in an embedded operating system or a DSP (Digital Signal Processing) system, in order to improve the data transmission rate and the system efficiency in use, the data can be transmitted with the DMA technology.

FIG. 1 is a schematic block diagram of a data transmission system using a conventional DMA technology. The DMA technology is applied in the embedded operating system or DSP system. The system includes a CPU 100, a DSP 101, a RAM 102, a DMA controller 103 and one or more peripheral devices 104.

The CPU 100 is coupled to a control bus of the system. The DSP 101, the RAM 102, the DMA controller 103 and the peripheral equipment 104 are coupled to the control bus and a DMA bus of the system. Under the CPU 100 control, each unit conducts its data transmission. In other words, the CPU 100 conducts the data transmission between the units in the system by the control bus.

When adopting the DMA to conduct data transmission, namely DSP 101 sends a data transmission request to CPU 100, the DMA controller 103 is granted the control right of the control bus in the system, so that the DMA controller 103 controls the data transmission between the RAM 102 and a peripheral device 104 via the DMA bus. It should be noted that when the number of the RAM 102 in the system is more than one, the DMA controller 103 controls-the data transmission between the different RAMs 102 via the DMA bus. Additionally, the DSP 101 may be more than one, they respectively send data transmission respective requests to the CPU 100.

FIG. 2 is a flow chart of a data transmission method using the conventional DMA technology. At 200, the CPU receives data transmission requests from the peripheral devices 104 or the RAM 102 in the system. For example, the purpose of the requests is to transmit the data in the RAM 102 or the peripheral equipment 104 to the RAM 102 or the peripheral equipment 104.

At 201, the CPU 100 stores the data transmission requests into a presetting physical storage sequence thereof. The presetting physical storage sequence is used to store the requests from the peripheral devices 104 or the RAM 102. The requests from the peripheral equipment or the RAM are arranged respectively according to their priorities or their sequence of the requests.

At 202, if the DMA bus is idle, the DSP 101 sends a DMA request to the CPU to apply for the data transmission with the DMA technology. At 203, the CPU 100 configures the DMA controller 103 according to the stored topside data transmission request in the physical storage sequence and then deletes the configured data transmission request in the physical storage sequence.

The configuration process of the DMA controller 103 includes the following operations. According to the topside data transmission request stored in the physical storage sequence, the CPU 100 determines where the request comes from, from the peripheral equipment 104 or the RAM 102, where to transmit the data, to the peripheral equipment 104 or the RAM 102. Then the CPU 100 designates the DMA controller 103 to configure the source peripheral device or source RAM for the data transmission to the destination RAM or destination peripheral device.

At 204, according to the configuration set by the CPU 100, the DMA controller 103 controls the DMA bus and the control bus in the system and transmits the data from the source peripheral device or the source RAM to the destination RAM or the destination peripheral device. At 205, the DMA controller 103 determines if this data transmission is finished. If so, the process goes to 206. If not, the process goes back to 204.

It is assumed that the data transmission is finished. At 206, the DMA controller 103 sends a message to the CPU 100 that the data transmission is finished. At 207, the CPU determines if all data transmission requests stored in the physical storage sequence are carried out. If all of the requests are processes, the process ends. If there are still some requests to be processed, the process goes back to 202.

The inventors herein have learned from the data transmission using the DMA technology that there are several unsatisfactory issues. First, after the DMA controller 103 completes one data transmission operation every time while the CPU has not completed the data transmission requests stored in the physical storage sequence, it has to return to 202, which needs the CPU 100 to reconfigure the DMA controller for next data transmission. As a result, the CPU 100 has to respond frequently. Second, when the CPU 100 configures the DMA controller 103 for next data transmission, the DMA controller 103 is at idle condition, that is to say that there is a relative long time elapsed for the DMA controller 103 between this data transmission operation and a next data transmission operation. Thus the use efficacy of the DMA controller 103 is decreased. Third, the CPU may process other programs when it configures for the DMA controller's next data transmission, so that it may increase the idle time for the DMA controller, which leads to a lower data transmission efficacy of the DMA controller.

Thus there is a need for techniques for improving the data transmission efficacy of the DMA controller.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for increasing data transmission efficiency via DMA Controller. According to one aspect of the present invention, a data transmission system comprises a data source unit, a data destination unit, a CPU, a DMA command queue controller and a DMA controller. The data destination unit provides data required to be transmitted and the data destination unit is to receive the data. The CPU receives data transmission requests in a batch. The DMA command queue controller is provided to store the data transmissions requests from the CPU. The DMA controller is configured by the DMA command queue controller according to the data transmission requests and controls the data transmission between the data source unit and the data destination unit.

The present invention may be implemented in many forms including a method, a process, an apparatus or a part of a system. According to one embodiment, the present invention is an computing apparatus comprising:
a data source unit providing data to be transmitted;
a data destination unit to receive the data transferred from the data source unit;
a CPU receiving data transmission requests for data transmission;
a DMA command queue controller orderly storing the data transmissions requests from the CPU; and
a DMA controller orderly configured by the DMA command queue controller according to the data transmission requests and controlling the data transmission between the data source unit and the data destination unit.

According to another embodiment, the present invention is a method for data transmission in a system, the system comprising at least a data source unit, a data destination unit, a CPU, a DMA command queue controller, and a DMA controller, the method comprises:
receiving in the CPU data transmission requests;
writing a batch of data transmission requests into the DMA command queue;
configuring the DMA controller according to a topside request in the batch of data transmission requests which is stored in the DMA command queue controller;
deleting the configured data transmission request so that a next request in the batch of data transmission requests in the DMA command queue controller is pushed to the topside request;
transmitting data from the data source unit to the data destination unit according to the DMA controller's configuration.

One of the objects, features, and advantages of the present invention is to provide an efficient accessing mechanism of a file allocation table.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a schematic block diagram of a data transmission system using a conventional DMA technology;

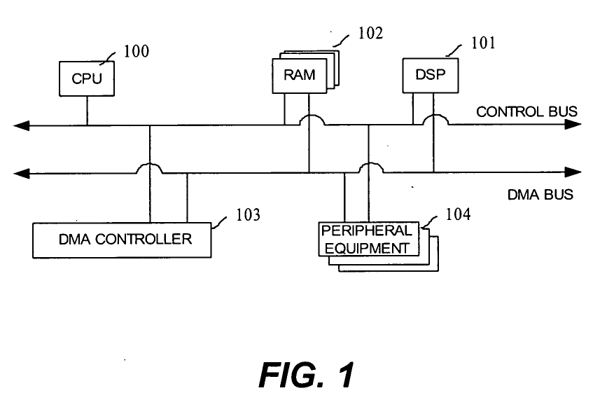

FIG. 2 is a flow chart of a data transmission method using the conventional DMA technology;

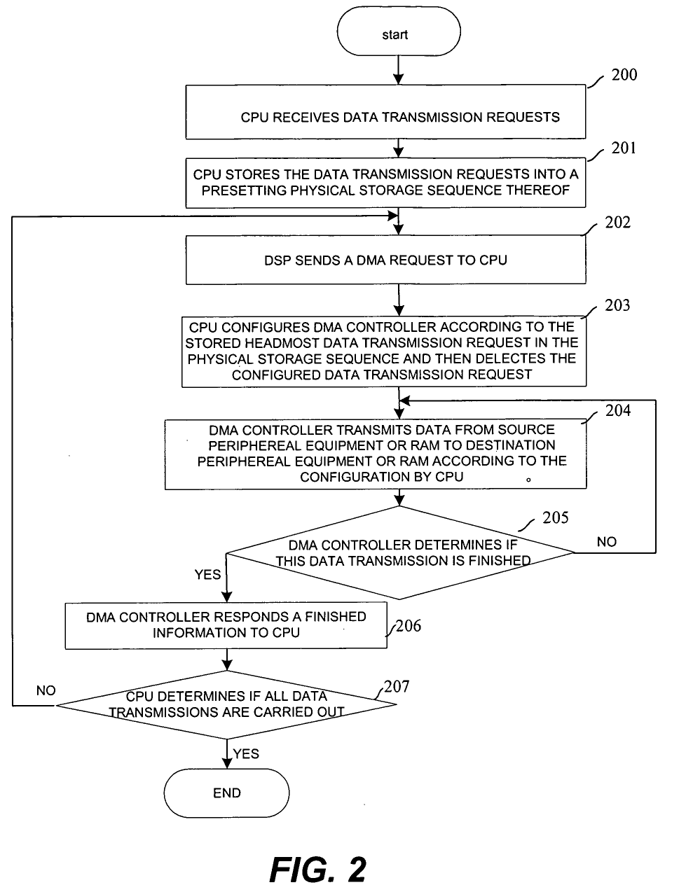

FIG. 3 is a schematic block diagram of a data transmission system of the present invention; and

FIG. 4 is a flow chart of a data transmission method using in the data transmission system in the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

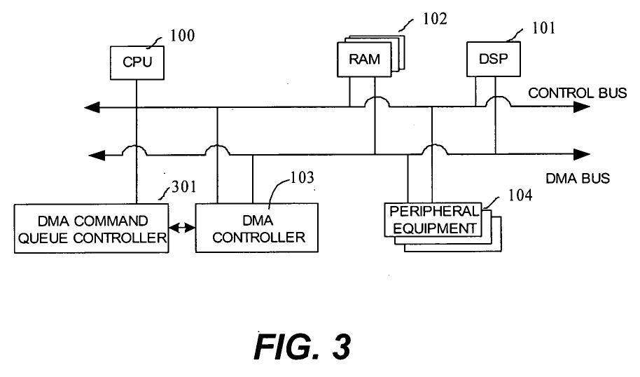

Referring now to the drawings, in which like numerals refer to like parts throughout the several views. FIG. 3 is an exemplary schematic block diagram according to one embodiment of the present invention. The system as shown in FIG. 3 includes a CPU 100, a DSP 101, a DMA controller 103, a DMA command queue controller 301, at least one data storage unit, one or more peripheral equipments 104 and a RAM 102. Any of peripheral equipments 104 and the RAM 102 may be a data source unit or a data destination unit in the present invention.

The CPU 100 and the DMA command queue controller 301 are coupled to a control bus. The DSP 101, the RAM 102, the DMA controller 103 and the peripheral equipments 104 are coupled to the control bus and a DMA bus. Controlled by the CPU 100, each unit operates cooperatively and conducts data transmission.

When adopting the DMA technology to conduct the data transmission, the DMA controller 103 is granted a control right of the control bus so that the DMA controller 103 controls the data transmission between the RAM 102 and the peripheral equipment 104 (assuming one equipment) via the DMA bus. It should be noted that when the number of the RAM 102 in the system is more than one, the DMA controller 103 controls the data transmission between the different RAMs 102 via the DMA bus. Additionally, the DSP 101 may be more than one, they respectively send data transmission requests to the CPU 100.

Different with the prior art system, the present invention discloses that the CPU 100 writes all data transmission requests which are already stored in its physical storage sequence into a DMA command queue controller 301 in batches at one time via the control bus, and then the DMA command queue controller 301 stores the received data transmission requests in order according to their execution sequence. Each data transmission request includes addresses of the source device (e.g., a peripheral equipment or a RAM, and a destination peripheral equipment or a source RAM), and a data lengthen in the data transmission.

Additionally, in the present invention, instead of sending the DMA request to the CPU 100 in the prior art system, the DSP 101 sends a DMA request to the DMA command queue controller 301 via an interface between the DMA command queue controller 301 and the DSP 101 or the control bus. After receiving the DMA request, according to a topside request in the data transmission requests which are stored in the DMA command queue controller 301, the DMA command queue controller 301, instead of the CPU 100, will configure the DMA controller 103 via an interface between the DMA command queue controller 301 and the DMA controller 103 or the control bus.

According to one embodiment, the DMA controller 103 controls the DMA bus and the control bus in the data transmission system and transmits the data from a device to a destination device according to the configuration by the DMA command queue controller 301.

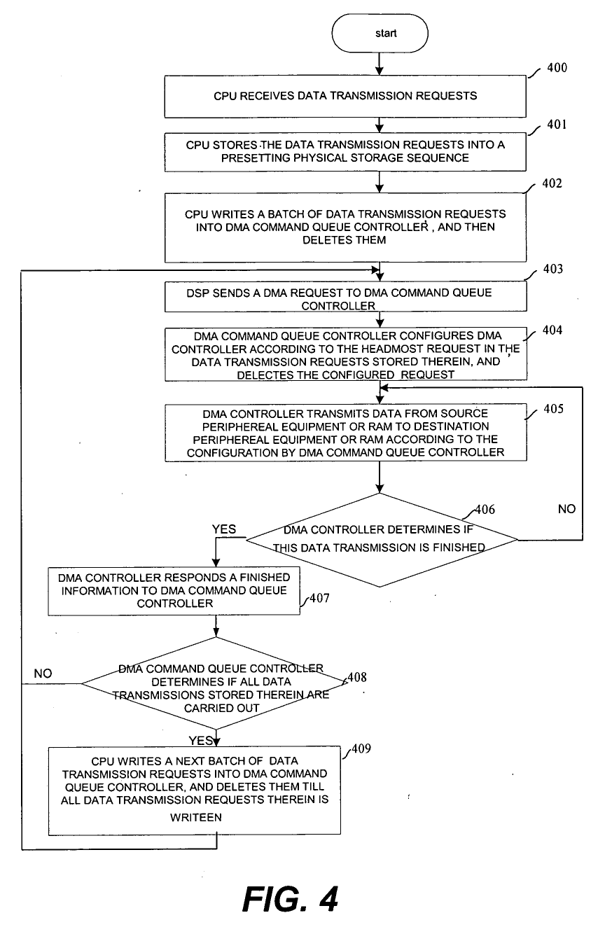

Referring now to FIG. 4, there shows a process or flowchart of carrying out data transmission in accordance with one embodiment of the present invention. The process may be implemented in software, hardware or in a combination of both. The process shall be understood in conjunction with FIG. 3.

At 400, the CPU 100 receives data transmission requests from either a source or destination device. Each data transmission request includes addresses of a source device, a destination device and a data lengthen in the data transmission. The CPU stores the data transmission requests at 401 into a presetting physical storage sequence thereof in order. At 402, the CPU 100 writes a batch of data transmission requests which are already stored in the physical storage sequence into the DMA command queue controller 301 according to sequences, and then deletes the batch of data transmission requests from the physical storage sequence after they have been written into the DMA command queue controller 301.

The number of each batch of data transmission requests is determined by the volume of the DMA command queue controller 301. The DMA command queue controller 301 stores the received data transmission requests in a queue list thereof in order according to their respective execution sequences.

At 403, if the DMA bus is idle, the DSP 101 sends a DMA request to the DMA command queue controller 301 for the DMA bus. The DSP 101 will detect the DMA bus in real-time. When it detects that the DMA bus is available, it will send the DMA request to the DMA command queue controller 301. The DMA command queue controller 301 will at 404 configure the DMA controller 103 according to a topside request in the batch of data transmission requests which are stored in the DMA command queue controller 301, and deletes the configured data transmission requests.

At 405, according to the configuration set by the DMA command queue controller 301, the DMA controller 103 controls the DMA bus and the control bus and transmits the data from the source device to the destination device. The DMA controller determines at 406 if the data transmission has been accomplished. If so, the process goes to 407. If not, the process goes back to 405.

It is now assumed that the DMA controller has determined at 406 that the data transmission has been accomplished. At 407, the DMA controller 103 sends out an acknowledgement (the finished information) to the DMA command queue controller 301 that the data transmission has been accomplished.

At 408, the DMA command queue controller 301 determines if all data transmission requests stored therein have been carried out. If the requests stored therein have been carried out, the process goes 409, where the CPU 100 writes a next batch of data transmission requests into the DMA command queue controllers 301 according to sequence, and deletes those written data transmission requests until all data transmission requests has been written. If the stored requests have not been carried out, the process goes 403 to continue the remaining requests respectively.

From the description herein, it may be appreciated by those skilled in the art that in the present invention, the CPU 100 only needs to respond to the request of the DMA command queue controller 301, the responding frequency has been reduced significantly. Since the DMA command queue controller 301 responds to the DMA request from the DSP 101, the DMA data transmission efficiency has been greatly improved, which can now realize real-time full bandwidth data transmission.

The DMA command queue controller 301 is provided in the present invention, so the CPU 100 is able to send the data transmission requests to the DMA command queue controller 301 when the CPU 100 is idle. As a result, the present invention eliminates the command conflicts in which when the CPU 100 is busy, it has to deal with DMA interruptions. Because there are many data transmission requests stored in the DMA command queue controller 301, which is determined by the DMA command queue controller's volume, and the DMA command queue controller 301 configures the data transmission for the DMA controller 103, the CPU does not need to frequently respond to the requests. Furthermore, the DMA command queue controller 301 is configured to deal with data transmission requests, it does not have to process other events like CPU does, so the DMA command queue controller 301 can respond to the DMA request of the DSP 101 in real time, thereby improving the using efficacy of the data transmission system.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. For example, the system shown in FIG. 3 may be used in-a desktop computer, a laptop computer or any portable or non-portable computing device. Accordingly, the scope of the present invention is defined by the appended claims rather than the foregoing description of embodiments.

What is claimed is:

1. A computing apparatus comprising:
a data source unit providing data to be transmitted;
a data destination unit to receive the data transferred from the data source unit;
a CPU receiving data transmission requests for data transmission;
a DMA command queue controller orderly storing the data transmissions requests from the CPU; and
a DMA controller orderly configured by the DMA command queue controller according to the data transmission requests and controlling the data transmission between the data source unit and the data destination unit.

2. The computing apparatus as claimed in claim 1, wherein the data source unit is a RAM or a peripheral device, and wherein the data destination unit is a RAM or a peripheral device.

3. The computing apparatus as claimed in claim 1, wherein the CPU writes the data transmission requests into the DMA command queue controller in batches according to sequences, and wherein the DMA command queue controller orderly stores the received data transmission requests according to their execution sequence.

4. The data transmission system as claimed in claim 3, wherein a quantity of each batch of data transmission requests are determined by a volume of the DMA command queue controller.

5. The computing apparatus as claimed in claim 1, wherein each data transmission request includes addresses of the data source unit and the data destination unit, and a data lengthen required to be transmitted.

6. The computing apparatus as claimed in claim 1, wherein the CPU sends the data transmission requests to the DMA command queue controller when the CPU is idle.

7. The computing apparatus as claimed in claim 1, wherein the DMA command queue controller configures the DMA controller according to a topside data transmission request in the data transmission requests which is stored in the DMA command queue controller, and then deletes the configured data transmission requests.

8. The computing apparatus as claimed in claim 1, further comprising a control bus and a DMA bus, and wherein the CPU and the DMA command queue controller are connected to the control bus, and wherein the DSP, the DMA controller, the data source unit and the data destination unit are connected to the control bus and the DMA bus.

9. The computing apparatus as claimed in claim 1, further comprising a DSP sending DMA requests to the DMA command queue controller.

10. A method for data transmission in a system, the system comprising at least a data source unit, a data destination unit, a CPU, a DMA command queue controller, and a DMA controller, the method comprising:
receiving in the CPU data transmission requests;
writing a batch of data transmission requests into the DMA command queue;
configuring the DMA controller according to a topside request in the batch of data transmission requests which is stored in the DMA command queue controller;
deleting the configured data transmission request so that a next request in the batch of data transmission requests in the DMA command queue controller is pushed to the topside request;
transmitting data from the data source unit to the data destination unit according to the DMA controller's configuration.

11. The data transmission method as claimed in claim 10, wherein before configuring the DMA controller, a DSP provided in the data transmission system sends a DMA request to the DMA command queue controller.

12. The data transmission method as claimed in claim 10, wherein a quantity of each batch of data transmission requests are determined by a volume of the DMA command queue controller.

13. The data transmission method as claimed in claim 10, wherein the DMA command queue controller stores the received data transmission requests in order according to their execution sequence.

14. The data transmission method as claimed in claim 10, wherein when the data transmission has accomplished, the DMA controller response an information to the DMA command queue controller.

15. The data transmission method as claimed in claim 10, wherein the DMA command queue controller determines if all requests in the batch of data transmission requests stored therein have been carried out, if so, the CPU writes a next batch of data transmission requests into the DMA command queue controller.

16. A computing apparatus comprising:.
a data source unit providing data to be transmitted;
a data destination unit to receive the data transferred from the data source unit;
a CPU configured to receive a batch of data transmission requests from either one of the data source unit or data destination unit;
a DMA command queue controller configured to store the data transmissions requests from the CPU in one transaction; and
a DMA controller configured by the DMA command queue controller according to the data transmission requests to control transmission of the data between the data source unit and the data destination unit.

17. The computing apparatus as claimed in claim 16 further comprising:
a control bus; and
a DMA bus, wherein the CPS communicates with the DMA command queue controller via the control bus, while the transmission of the data between the data source unit and the data destination unit is carried out over the DMA bus.

18. The computing apparatus as claimed in claim 1, wherein the computing apparatus is at least part of a computing device.
